(19) United States
(12) Patent Application Publication
(10) Pub. No.: US 2015/0030734 A1
(43) Pub. Date: Jan. 29, 2015

(54) PROVIDING HOMESTYLE EGG PRODUCT PORTIONS

(71) Applicant: CARGILL, INCORPORATED, WAYZATA, MN (US)

(72) Inventors: Robert E. Lee, St. Louis Park, MN (US); Aaron K. Martin, Albertville, MN (US); Donald R. Roberts, St. Michael, MN (US)

(21) Appl. No.: 14/512,905

(22) Filed: Oct. 13, 2014

Related U.S. Application Data
(62) Division of application No. 13/102,630, filed on May 6, 2011.
(60) Provisional application No. 61/396,438, filed on May 27, 2010.

(51) Int. Cl. A23L 1/32

(52) U.S. Cl. CPC A23L 1/32
USPC 426/298

(57) ABSTRACT

An apparatus for providing homestyle egg product portions on a commercial scale is described. The apparatus includes a plurality of moving heated pockets, and a plurality of mixers. Each heated pocket is capable of holding an egg product portion, and each mixer is capable of stirring an egg product portion held in a heated pocket to yield a stirred egg product portion. The apparatus can further include a plurality of groupers. Each grouper is capable of gathering stirred egg product portions held in a moving heated pocket. Methods for producing homestyle egg product portions on a commercial scale are also described.

### CROSS REFERENCE TO RELATED APPLICATION

This application claims the benefit of U.S. provisional application Ser. No. 61/396,438 filed May 27, 2010 entitled PROVIDING HOMESTYLE EGG PRODUCT PORTIONS, which is hereby incorporated by reference in its entirety.

### FIELD OF THE INVENTION

The present disclosure relates to providing homestyle egg product portions.

### BACKGROUND OF THE INVENTION

Many types of restaurants, in particular quick serve restaurants, have a need for prepared eggs. It can be time consuming and labor intensive to prepare eggs in these restaurants after each customer order, and it may therefore be preferable to have high quality prepared egg products on hand which require less on-site time and labor before presentation to a customer. These prepared eggs can be provided in portions for use as standalone entrees or can be used in breakfast burritos, egg sandwiches, or the like.

### SUMMARY OF THE INVENTION

One aspect of the invention features an apparatus for providing homestyle egg product portions on a commercial scale. The apparatus includes a plurality of moving heated pockets, and a plurality of mixers. Each heated pocket is capable of holding an egg product portion, and each mixer is capable of stirring an egg product portion held in a heated pocket to yield a stirred egg product portion. The apparatus also includes a means for further cooking the egg product portions.

In some embodiments, the apparatus further includes a plurality of groupers. Each grouper is capable of gathering stirred egg product portions held in a moving heated pocket.

In some embodiments, the plurality of heated pockets is capable of being conveyed on a belt. In other embodiments, the plurality of heated pockets is held within a temperature range of from 250° F. to 300° F. (121° C. to 149° C.). Each heated pocket has a base and a side. In some embodiments, the base of each heated pocket is substantially flat and horizontal. In other embodiments, the angle between the base and the side of the heated pocket is approximately 90 degrees. In other embodiments, the angle is approximately between 90 and 160 degrees.

In some embodiments, each of the plurality of mixers has a device having one or more fingers.

Another aspect of the invention features a method for producing homestyle egg product portions on a commercial scale. The method includes providing a plurality of moving heated pockets, placing an egg product portion into each heated pocket, mechanically stirring the egg product portions within the heated pockets to yield stirred egg product portions, mechanically gathering the stirred egg product portions to yield gathered egg product portions, and further cooking the gathered egg product portions to yield homestyle egg product portions.

Yet another aspect of the invention features a method for producing homestyle egg product portions on a commercial scale. This method includes providing a plurality of moving heated pockets, placing an egg product portion into each heated pocket, mechanically stirring the egg product portions within the heated pockets to yield stirred egg product portions, and further cooking the stirred egg product portions to yield homestyle egg product portions.

Some embodiments of the above methods can further include the step of cooling the homestyle egg product portions to yield reduced temperature homestyle egg product portions. The reduced temperature homestyle egg product portions can also be packaged.

In some embodiments, a release agent is added to the heated pocket before the egg product portion is placed into the heated pocket. The release agent is preferably soybean oil.

In some embodiments, the egg product portions can be made up of whole eggs, egg whites, a combination of whole eggs and egg whites, whole eggs with food particulates, egg whites with food particulates, or a combination of whole eggs and egg whites with food particulates. The food particulates can include pepper pieces, onion pieces, tomato pieces, or bacon pieces.

In some embodiments, the temperature of the heated pockets is within the range of between 250° F. and 300° F. (121° C. and 149° C.). In other embodiments, the temperature of the heated pockets is within the range of between 270° F. and 300° F. (132° C. and 149° C.).

### BRIEF DESCRIPTION OF THE DRAWINGS

FIG. 1 is a perspective view of an embodiment of the present invention.

FIG. 2 is a perspective view of a portion of an embodiment of the present invention.

FIG. 3 is a perspective view of a heated pocket in accordance with the invention.

FIG. 4a1 is a perspective view of a heated pocket situated on a belt.

FIG. 4a2 is a side view of a heated pocket situated on a belt.

FIG. 4b1 is a perspective view of a heated pocket situated on a belt.

FIG. 4b2 is a side view of a heated pocket situated on a belt.

FIG. 5a is a perspective view of a mixer and moving heated pocket.

FIG. 5b is a perspective view of a mixer and moving heated pocket.

FIG. 5c is a perspective view of a mixer and moving heated pocket.

FIG. 5d is a perspective view of a mixer and moving heated pocket.

FIG. 6a is a perspective view of a grouper and moving heated pocket.

FIG. 6b is a perspective view of a grouper and moving heated pocket.

FIG. 6c is a perspective view of a grouper and moving heated pocket.

FIG. 6d is a perspective view of a grouper and moving heated pocket.

FIG. 6e is a perspective view of a grouper and moving heated pocket.

FIG. 7 is a schematic perspective view of a heated pocket and a device adding a release agent.

FIG. 8a is a schematic perspective view of a heated pocket and a device adding egg product.

FIG. 8b is a schematic perspective view of a heated pocket and devices adding egg product and food particulates.

FIG. 9 shows a cross section of a cooked frozen egg product portion.

FIG. 10 shows a cross section of a cooked frozen egg product portion.

FIG. 11 shows a cross section of a cooked frozen egg product portion.

FIG. 12 shows a cross section of a cooked frozen egg product portion.

FIG. 13 shows a cross section of a cooked frozen egg product portion.

FIG. 14 shows a cross section of a cooked frozen egg product portion.

### DETAILED DESCRIPTION OF THE INVENTION

The term “egg product” as used herein, means a composition made of eggs which may include food particulates. Egg product can include any combination of whole egg material, egg white material, and/or egg yolk material.

The egg product may additionally include food particulates. The food particulates can be any pieces of food typically combined with eggs to make varieties of omelets or other egg-based dishes. The food particulates can be vegetable pieces, meat pieces, cheese pieces, fruit pieces, or any mixture thereof. The vegetable pieces can include, but are not limited to, pieces of one or more vegetables including onion, pepper (green, chili, jalapeno, etc), tomato, potato, broccoli, cauliflower, carrot, corn, garlic, spinach, beans, mushrooms, squash, celery, sweet potato, yam, olive, artichoke, peas, ginger, water chestnut, and bamboo shoots. The meat pieces can include, but are not limited to, pieces of bacon, sausage, ham, Canadian bacon, turkey, and chicken. The fruit pieces can include, but are not limited to, pieces of one or more fruits including apple, pear, peach, blueberry, raspberry, strawberry, pineapple, orange, raisin, apricot, cherry, and banana.

The present invention pertains to apparatuses and processes for producing homestyle egg product portions on a commercial scale. The term “commercial scale”, as used herein, refers to the production on a scale in which relatively large numbers of the homestyle egg product portions can be made at the same time. This is in contrast to homestyle egg product portions made by hand. In some embodiments, homestyle egg product portions can be made utilizing the present invention at a rate of at least 500 units per hour.

### Structure

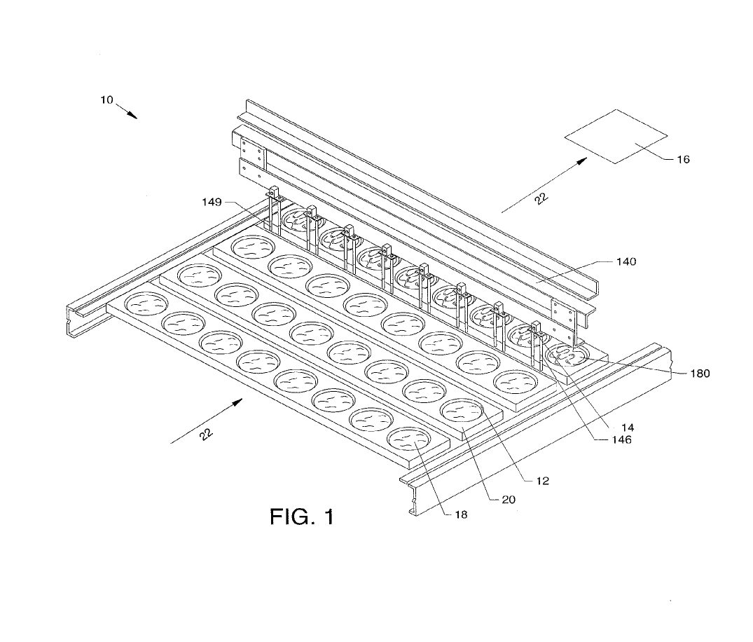

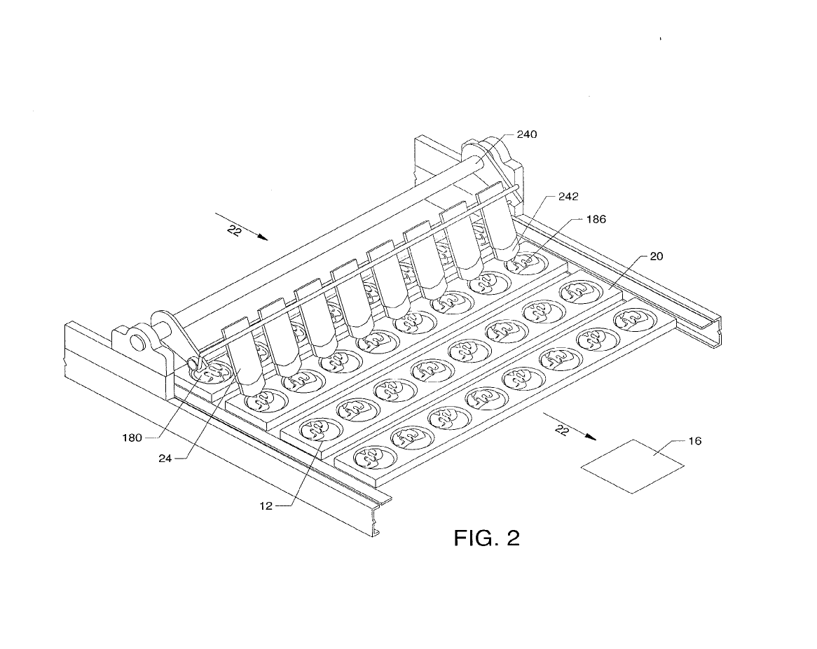

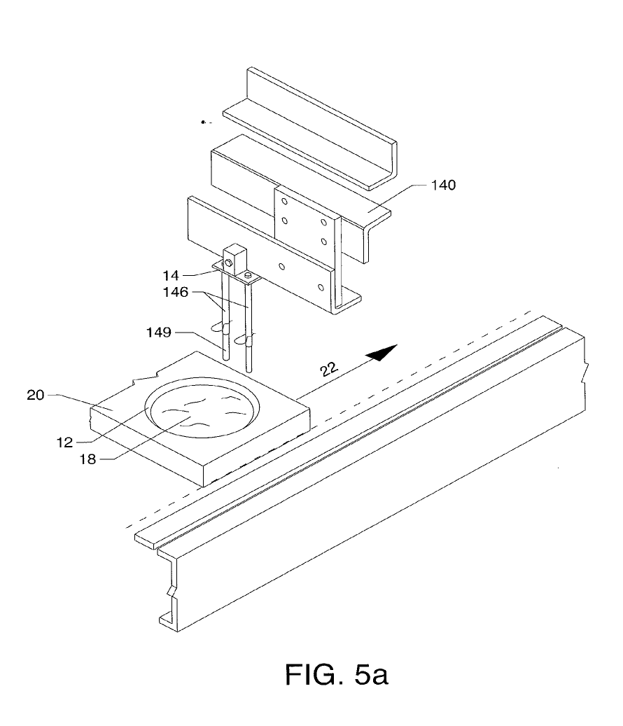

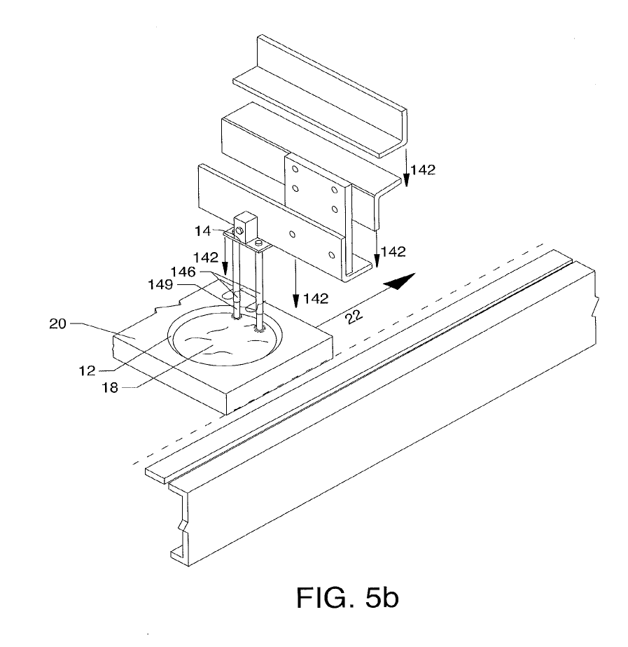

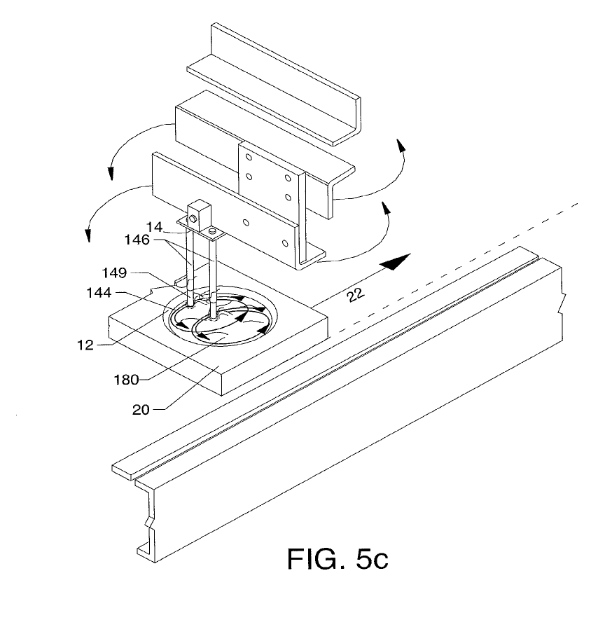

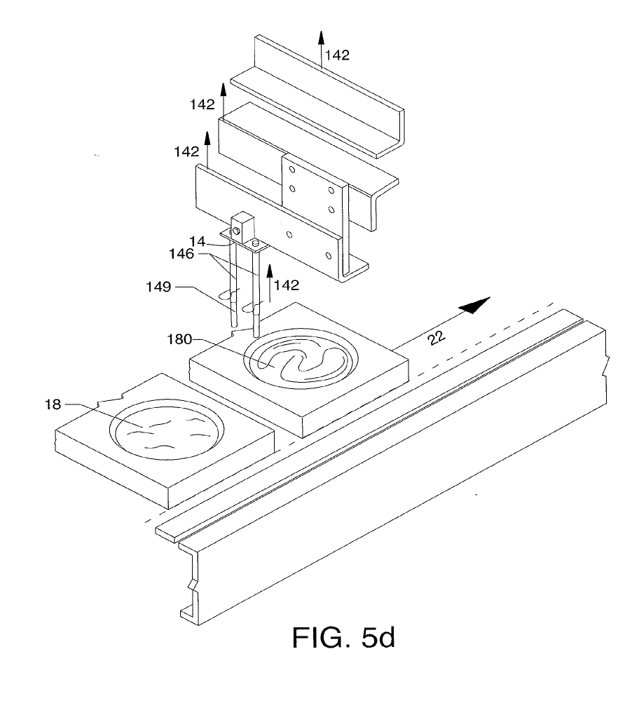

Referring to FIG. 1, an apparatus 10 for providing homestyle egg product portions on a commercial scale includes a plurality of moving heated pockets 12, a plurality of mixers 14, and a means for further cooking egg product portions. Egg product portions 18 are held in the heated pockets 12. The heated pockets 12 can be structurally situated on a belt 20. The belt 20, and the heated pockets 12 thereupon, can move axially 22. The plurality of mixers 14 are mounted on a support structure 140 above the moving heated pockets 12. Referring to FIG. 5b, the mixers 14 can articulate vertically 142 into the egg product portions 18 within the heated pockets 12. Referring to FIG. 5c, once the mixers 14 contact the egg product portions 18, the mixers can stir 144 the egg product portions 18. Egg product portions which have been stirred are referred to as stirred egg product portions 180. In some embodiments, the stirred egg product portions 180 can then proceed to a further cooking apparatus 16 for further cooking the stirred egg product portions 180. In other embodiments, referring to FIG. 2, the stirred egg product portions 180 can be gathered together within the heated pockets by a plurality of groupers 24.

Each heated pocket 12 is a heated container capable of holding an egg product portion 18. An egg product portion 18 is an amount of egg product. This amount of egg product can be any amount useful in utilizing the apparatus of the present invention. Particularly, the egg product portion 18 is an appropriate amount to fit into a heated pocket 12 in an embodiment of the present invention. Different embodiments of the present invention may call for different sized heated pockets 12, and therefore the egg product portion 18 to be placed within the heated pockets 12 will vary.

The heated pockets 12 are held at a sufficient temperature to cook the egg product portions held within. The heated pockets 12 can be heated by any method known in the art, including, but not limited to, flame or induction. In some embodiments, the heated pockets 12 can be held within a temperature range of from 200° F. to 350° F. (93° C. to 177° C.). In other embodiments, the heated pockets 12 can be held within a temperature range of from 250° F. to 350° F. (121° C. to 177° C.). In yet other embodiments, the heated pockets 12 can be held within a temperature range of from 250° F. to 300° F. (121° C. to 149° C.). In yet other embodiments, the heated pockets 12 can be held within a temperature range of from 270° F. to 300° F. (132° C. to 149° C.). In yet other embodiments, the heated pockets 12 can be held within a temperature range of from 270° F. to 290° F. (132° C. to 143° C.). In yet other embodiments, the heated pockets 12 can be held at a temperature of approximately 275° F. (135° C.).

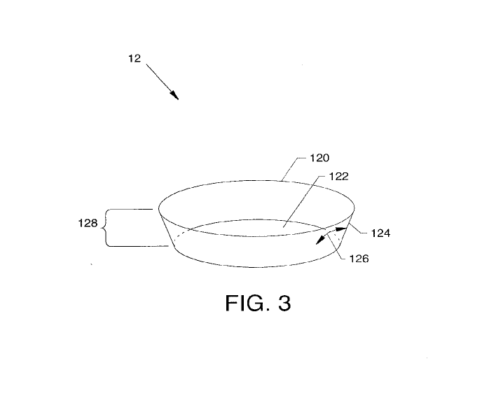

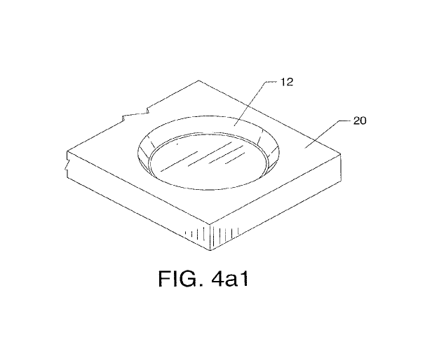

The size and shape of the heated pockets 12 can vary depending upon the size and shape of the homestyle egg product portion desired from the present invention. Referring particularly to FIG. 3, a heated pocket 12 has a top 120, a base 122, a depth 128, a side or sides 124, and an angle 126 between the side 124 and base 122. The top 120 of the heated pocket 12 will remain open such that egg product portions 18 can be deposited into the heated pocket 12. The top 120 of the heated pocket 12 can be any known shape including, but not limited to, circular, oval, rectangular, or triangular. Similarly, the base 122 of the heated pocket 12 can be any shape known the art useful for cooking egg product portions 18. Typically, the shape of the top 120 and the base 122 of the heated pocket 12 will be substantially similar, but can differ in size depending on the angle 126 between the side 124 and the base 122 of the heated pocket 12. In embodiments where the angle 126 is 90 degrees, the size of the top 120 and base 122 will be substantially the same. In embodiments where the angle 126 is greater than 90 degrees, the size of the top 120 will be greater than the base 122. In some embodiments, however, the top 120 and base 122 can vary in shape. The base 122 of the heated pocket 12 can be substantially flat, convex or concave or a combination of the foregoing.

The size of the top 120 of the heated pockets 12, the depth 128 of the heated pockets 12, and the angle 126 between the side 124 and base 122 of the heated pockets 12 can all be varied to produce various sized and shaped homestyle egg product portions. In some embodiments, the size (in surface area) of the top 120 of the heated pockets 12 can range from 10 inches to 40 inches (25.4 cm to 101.6 cm). In other embodiments, the size of the top 120 of the heated pocket 12 can range from 15 inches to 30 inches (38.1 cm to 76.2 cm). In yet other embodiments, the size of the top 120 of the heated pocket 12 can range from 18 inches to 26 inches (45.7 cm to 66.0 cm). In yet other embodiments, the size of the top 120 of the heated pocket 12 can be approximately 22 inches (55.9 cm). In yet other embodiments, the size of the top 120 of the heated pocket 12 can range from 4 inches to 18 inches (10.2 cm to 45.7 cm). In yet other embodiments, the size of the top 120 of the heated pocket 12 can range from 8 inches to 15 inches (20.3 cm to 38.1 cm).

In some embodiments, the depth 128 of the heated pocket 12 can range from 0.4 inches to 4 inches (1.0 cm to 10.2 cm). In other embodiments, the depth 128 of the heated pocket 12 can range from 0.5 inches to 3.5 inches (1.3 cm to 8.9 cm). In yet other embodiments, the depth 128 of the heated pocket 12 can range from 0.6 inches to 3 inches (1.5 cm to 7.6 cm). In yet other embodiments, the depth 128 of the heated pocket 12 can range from 0.65 inches to 2.5 inches (1.7 cm to 6.4 cm). In yet other embodiments, the depth 128 of the heated pocket 12 can range from 0.65 inches to 2 inches (1.7 cm to 5.1 cm). In yet other embodiments, the depth 128 of the heated pocket 12 can range from 0.7 inches to 1.5 inches (1.8 cm to 3.8 cm). In yet other embodiments, the depth 128 of the heated pocket 12 can range from 0.7 inches to 1 inch (1.8 cm to 2.5 cm).

The angle 126 between the base 122 and the side 124 of the heated pockets 12 can also vary depending upon the type and size of homestyle egg product portion desired. In some embodiments the angle 126 between the base 122 and side 124 of the heated pocket 12 can be between 90 and 160 degrees. In other embodiments, the angle 126 between the base 122 and side 124 of the heated pocket 12 can be between 110 and 160 degrees. In yet other embodiments, the angle 126 between the base 122 and side 124 of the heated pockets 12 can be between 120 and 150 degrees. In yet other embodiments, the angle 126 between the base 122 and side 124 of the heated pockets 12 can be between 130 and 140 degrees. In yet other embodiments, the angle 126 between the base 122 and side 124 of the heated pockets 12 can be approximately 90 degrees.

In some embodiments, each of the plurality of heated pockets 12 on a single apparatus can be the same size and shape. In other embodiments, the heated pockets 12 can be different sizes and shapes.

Referring again to FIG. 1, the heated pockets 12 are capable of moving axially 22. In some embodiments, the heated pockets 12 are situated upon a moving belt 20. The belt 20 can move at a rate useful for commercially producing homestyle egg product portions. In some embodiments the belt can move at a speed of from 3 feet/min to 45 feet/min (0.9 m/min to 13.7 m/min). In other embodiments the belt can move at a speed of from 3 feet/min to 25 feet/min (0.9 m/min to 7.6 m/min). In yet other embodiments the belt can move at a speed of from 5 feet/min to 20 feet/min (1.5 m/min to 6.1 m/min). In yet other embodiments the belt can move at a speed of from 10 feet/min to 15 feet/min (3.0 m/min to 4.6 m/min).

In some embodiments, the belt 20 can move at a continuous substantially constant speed. In other embodiments, the belt 20 can stop and restart. In yet other embodiments, the speed of the belt 20 can be varied during the running of the apparatus 10. In embodiments where the heated pockets 12 stop and restart, the heated pockets 12 will typically stop beneath the mixers 14 to allow the mixers 14 additional time to descend into the egg product portions 18 and stir them, before the heated pockets 12 continue to move axially 22.

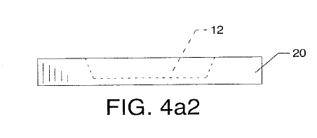

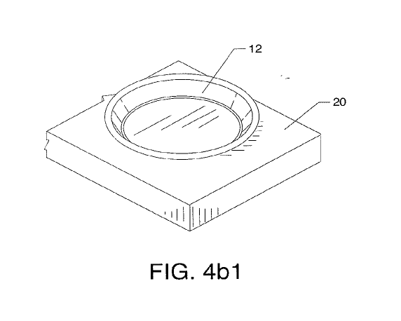

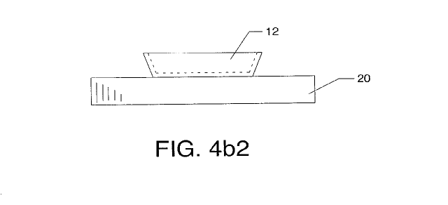

The heated pockets 12 can be structurally situated upon the moving belt 20 in any manner known. The heated pockets 12 can typically be situated in evenly spaced rows upon the belt 20. However, other arrangements of the heated pockets on the belt are possible. In some embodiments, referring to FIGS. 4a1 and 4a2, the heated pockets 12 can consist of depressions on the belt 20. In other embodiments, referring to FIGS. 4b1 and 4b2, the heated pockets 12 can consist of pan-shaped containers supported on top of the belt 20.

Other configurations of moving heated pockets are also contemplated by the present invention. In addition to being rigidly mounted to belts, in some embodiments the heated pockets can move or articulate relative to the belt. In some embodiments, the heated pockets are movable on a belt. In other embodiments, the heated pockets can rotate about a center point. In yet other embodiments, the heated pockets can be configured and cammed to move in an offset motion.

The heated pockets do not necessarily need to be situated upon a belt. In some embodiments, the heated pockets can be mounted to a chain or other mechanically moving structure. Other embodiments of the present invention are possible wherein the heated pockets are moved by a structure in other than a solely axial dimension, or other than solely in a horizontal plane. For example, the heated pockets may be moved axially and laterally, or may be moved in a vertical plane in a ferris-wheel like orientation, or may be moved in a spiral orientation.

Referring again to FIG. 1, mounted above the plurality of heated pockets 12 is a support structure 140 holding a plurality of mixers 14. The term “mixer”, as used herein, means a device which can be used to stir egg product portions 18 within a heated pocket 12. Any type of device capable of stirring eggs can be used. In some embodiments, the mixer 14 can include one or more fingers 146. The term “finger”, as used herein, refers to a rod which can be inserted into the egg product portion 18 within the heated pocket 12. The mixer 14 can include any number of fingers 146 useful for stirring the egg product portion 18 in the heated pocket 12. In some embodiments, the mixer 14 can be made of one finger 146. In other embodiments, the mixer 14 can be made of two fingers 146. In yet other embodiments, the mixer 14 can be made of greater than two fingers 146. In yet other embodiments, the mixer 14 can be shaped like a paddle. In yet other embodiments, the mixer 14 can be shaped like a coil. In yet other embodiments, the mixer 14 can be shaped like a whisk.

Referring to FIG. 5b, the mixers 14 are capable of articulating vertically 142. In some embodiments, the mixers 14 can articulate vertically 142 at an angle substantially perpendicular to the axial movement 22 of the heated pockets 12. In other embodiments, the mixers 14 are capable of articulating vertically 142 at a non-perpendicular angle relative to the axial movement 22 of the heated pockets 12.

The mixers 14 can articulate vertically 142 such that they descend into the egg product portions 18 held in the heated pockets 12. In some embodiments, the mixers 14 can descend such that they are lightly touching the base 122 of the heated pockets 12. In other embodiments, the mixers 14 can descend such that they are very nearly touching the base of the heated pockets 12. In yet other embodiments, the mixers 14 can maintain a distance of 0.05 inches (0.13 cm) from the base 122 of the heated pockets 12. In yet other embodiments, the mixers 14 can maintain a distance of 0.1 inches (0.25 cm) from the base 122 of the heated pockets 12. In yet other embodiments, the mixers 14 can maintain a distance of 0.25 inches (0.64 cm) from the base 122 of the heated pockets 12. In yet other embodiments, the mixers 14 can descend such they are only slightly immersed in the egg product portions 18.

Referring to FIG. 5c, once the mixers 14 have articulated vertically 142 such that they have descended into the egg product portions 18, the mixers 14 are capable of stirring 144 the egg product portions 18 held in the heated pockets 12. The mixers 12 can move in any manner useful to stir 144 the egg product portions 18. In some embodiments, the mixers 14 can move in a circular motion. In other embodiments, the mixers 14 can move in a zig-zag motion. In a particular embodiment, the mixers 14 can move clockwise in a circular motion, followed by moving in a circular counter-clockwise motion.

In embodiments of the present invention where the heated pockets 12 move axially 22 at a continuous rate, it can be important for the mixers 14 to descend and stir 144 the egg product portions 18 held within the heated pockets 12 quickly. In some embodiments, each mixer 14 must stir 144 an egg product portion 18 within 5 seconds. In other embodiments, each mixer 14 must stir 144 an egg product portion 18 within 4 seconds. In yet other embodiments, each mixer 14 must stir 144 an egg product portion 18 within 3 seconds. In yet other embodiments, each mixer 14 must stir 144 an egg product portion 18 within 2 seconds. In yet other embodiments, especially when the heated pockets 12 move at a particularly high speed, each mixer 14 must stir 144 an egg product portion 18 within 1 second or less.

In one particular example, when the heated pockets are moving at a continuous speed of approximately 4.1 feet/min (1.25 m/min) in the axial direction on the belt, the heated pockets are situated on a belt in evenly spaced rows, and the top of the heated pockets are circular with a 5 inch (12.7 cm) diameter with a gap of 0.5 inch (1.3 cm) between subsequent heated pockets, the mixers should stir each of the heated pockets for only 2 seconds.

After the plurality of mixers 14 has completed stirring 144 the egg product portions 18 in a particular group of heated pockets 12, referring to FIG. 5d, the mixers can again articulate vertically 142 such that they ascend to be situated above the moving heated pockets 12.

In the present invention, only a portion of the mixers 14 typically comes into contact with egg product portions 18 in the heated pockets 12. This contact portion 149 of the mixers 14 can be made of or coated with a composite material. This composite material can be a plastic composite material, a silicon composite material, or a plastic silicon composite material. The present invention also contemplates that other composite materials could be used. The cleanliness of the contact portion 149 of the mixers 14 is important to the preferred operation of the present invention, and the use of a composite material for the contact portion 149 can improve this attribute.

In some embodiments, the plurality of mixers 14 is also capable of moving axially above the heated pockets 12. In these embodiments, the mixers 14 can move axially with the heated pockets 12 at substantially the same rate and in the same direction as the heated pockets.

In some embodiments, there can be more than one set of a plurality of mixers above the heated pockets. In some embodiments, the apparatus will include a second plurality of mixers. In other embodiments, the apparatus will include a second and a third plurality of mixers. These other pluralities of mixers can be mounted to their own support structure above the heated pockets. Each plurality of mixers can be shaped differently from the others, and can have different stirring motions.

In operation of these embodiments, the egg product portions would be stirred multiple times by more than one mixer. For example, in embodiments with a second plurality of mixers, the egg product portions would be stirred for the second time by this second plurality of mixers.

In some embodiments, referring to FIG. 2, the apparatus additionally includes a plurality of groupers 24. The groupers 24 are mounted on a support structure 240 situated above the heated pockets 12. The plurality of groupers 24 is situated in a position subsequent to or downstream of the mixers 14 on the apparatus. Thus, a heated pocket 12 may only arrive beneath a grouper 24 after the egg product portion 18 held within it has been stirred 144 by a mixer 14. As described above, after being stirred 144, the egg product portions held within the heated pockets 12 are referred to as stirred egg product portions 180.

The term “grouper”, as used herein, means a device which can be used to gather the stirred egg product portions 180 within the heated pockets 12. The term “gather” refers to the compression of the stirred egg product portion 180 between the grouper 24 and a side 124 of the heated pocket 12. The gathering mechanism is described in more detail in the Use section below.

The groupers 24 are typically substantially thin, flat devices which are capable of descending into the heated pockets 12. The size of the portion of a grouper 24 which will come into contact with a stirred egg product portion 180 should be similar in size to and fit into the base 122 of a heated pocket 12.

Similar to the mixers 14, the contact portion 242 of the groupers 24 which comes in contact with the stirred egg product portions 180 can be made of or coated with a composite material. This composite material can be a plastic composite material, a silicon composite material, or a plastic silicon composite material, among others.

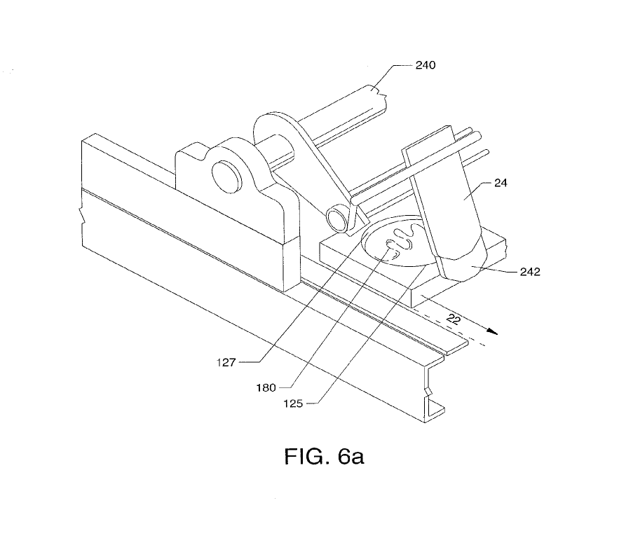

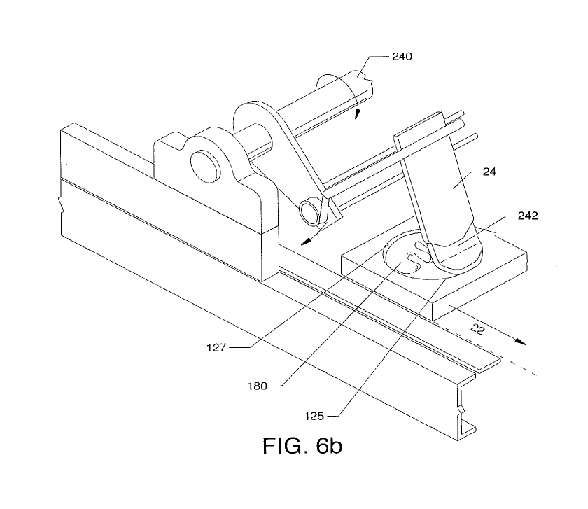

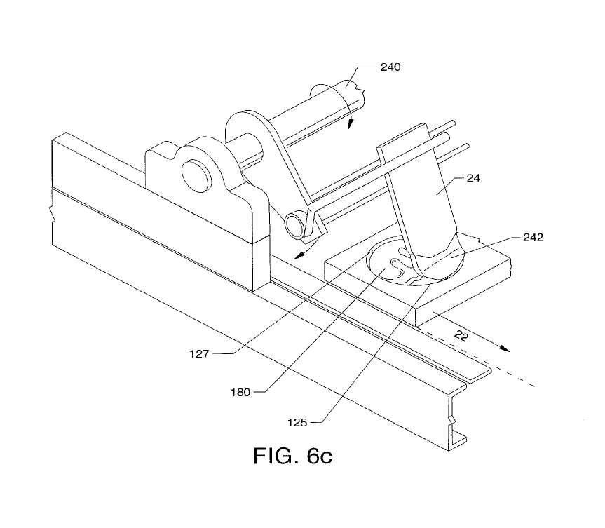

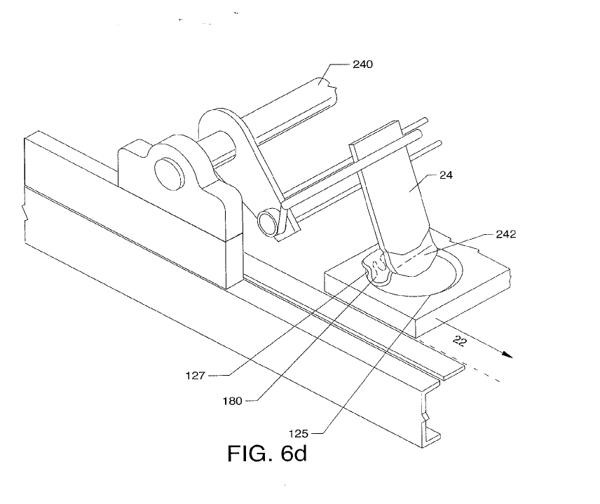

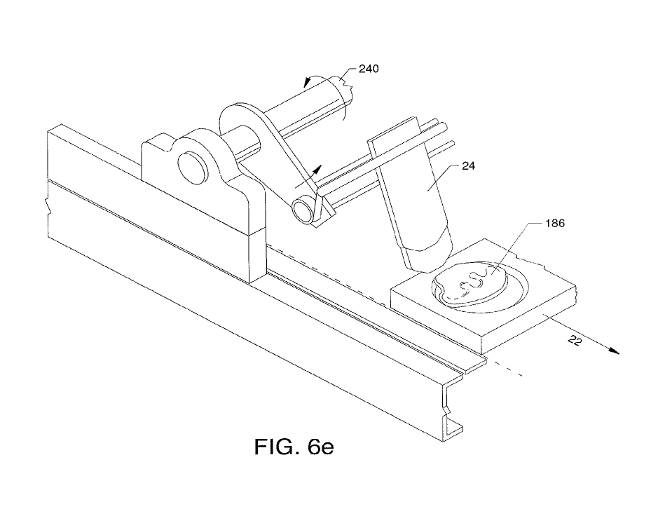

Referring to FIG. 6b, movement of the grouper support structure 240 causes the groupers 24 to descend into and contact the heated pockets 12. The groupers 24 can also include a spring or other mechanism which allows a continuous downward pressure onto the heated pocket such that the grouper can follow the contours of the side and base of the moving heated pocket. Once the grouper support structure 240 causes the groupers 24 to descend, the groupers 24 are held substantially rigid such that they do not move axially 22 in the direction of the belt. However, the exerted downward pressure can cause the groupers to move vertically as they follow the contours of the moving heated pockets 12. After the groupers 24 have sufficiently gathered the stirred egg product portions 180, the grouper support structure 240 can cause the groupers 24 to ascend above the moving heated pockets 12.

In most embodiments, the grouper support structure 240 does not move axially. In some embodiments, however, the grouper support structure 240 can move axially in the opposite direction from the axial movement 22 of the moving heated pockets 12.

The apparatus 10 of the present invention additionally includes a means for further cooking egg product portions. In some embodiments, this means for further cooking the egg product portions can consist of allowing the egg product portions to remain in the heated pockets until sufficiently cooked. In other embodiments, this means for further cooking the egg product portions can include utilization of a further cooking apparatus 16. This further cooking apparatus 16 can be a separate cooking unit subsequently cooperating with the apparatus 10 to complete a final cooking of the egg product portions. This unit can be a microwave oven unit, steam oven unit, convection oven unit, impingement oven unit, or other cooking unit known in the art.

In some embodiments, the egg product portions can be carried in the heated pockets 12 to the separate cooking unit. In other embodiments, the egg product portions can be removed or de-panned from the heated pockets 12 onto a separate moving belt which can carry the egg product portions to the separate cooking unit. This further cooking of the egg product portion does not substantially change the shape of the egg product portions. Instead, it ensures that the eggs are cooked to completion.

### Use

Referring to FIG. 7, the heated pockets 12 can first be coated with a release agent 26. The purpose of the release agent is to allow for easier removal of the egg product portions from the heated pockets 12 after completion of cooking, or for removal to proceed on a separate moving belt to a separate cooking unit. The release agent 26 can be an oil or other composition which can aid in the removal of the egg product portion from the heated pocket. The oil can be any oil typically used to remove cooked food from a skillet including, but not limited to, corn oil, canola oil, and soybean oil.

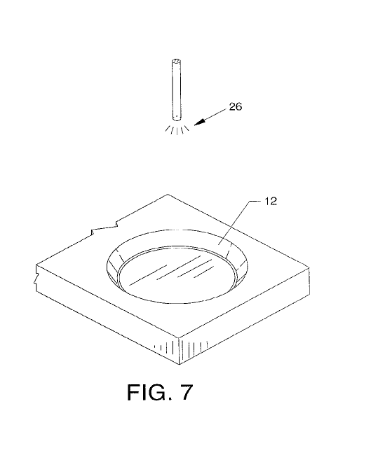

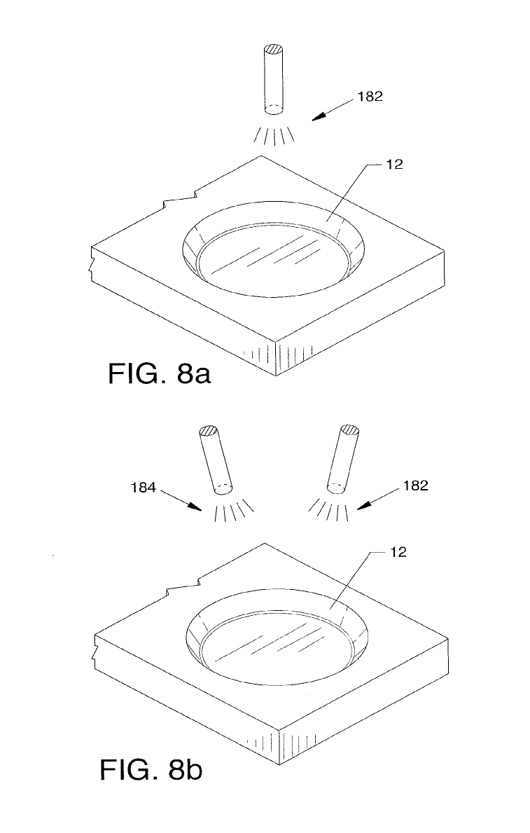

Referring to FIGS. 8a and 8b, egg product 182 is then placed into the heated pockets. Referring particularly to FIG. 8a, when the egg product 182 either does not include food particulates or the food particulates have been pre-mixed into the egg product, the egg product 182 can be added to the heated pocket 12 in one step. Referring particularly to FIG. 8b, in some instances, food particulates 184 may be added separately from egg product 182 into the heated pockets 12.

Referring once again to FIG. 1, as the heated pockets containing egg product portions move axially 22 toward the mixers 14, the egg product portions 18 begin to cook. Referring to FIGS. 5a-5d, once a row of heated pockets 12 is positioned below the mixers 14, the mixers 14 can stir 144 the egg product portions 18 within the heated pockets 12. Referring particularly to FIG. 5b, the mixers 14 articulate vertically 142 such that they descend into egg product portions 18 held in the heated pockets 12. As described above, the mixers 12 can descend until they lightly touch the base 122 of the heated pockets 12 prior to stirring. The mixers 12 can also descend such that they are within the egg product portions 18, but not touching the base 122 of the heated pocket 12.

Referring particularly to FIG. 5c, once the mixers 14 are inserted into the egg product portions 18, the mixers 14 then proceed to stir 144 the egg product portions 18. Referring particularly to FIG. 5d, after stirring, the mixers articulate 142 in the opposite direction and ascend and prepare to again descend into the next row of moving heated pockets 12 containing egg product portions 18.

The stirred egg product portions 180 can then be further cooked. In some embodiments, this further cooking can be done by simply retaining the stirred egg product portions 180 within the heated pockets 12 for a longer duration. In other embodiments, a further cooking apparatus 16 will provide another means for further cooking the stirred egg product portions 180. As described above, the means for further cooking can be an oven. The purpose of this further cooking step is to ensure complete cooking of the stirred egg product portions while maintaining a hand-made texture and appearance.

When utilizing the additional means for further cooking the stirred eggs product portions 180, the stirred egg product portions 180 can be removed from the heated pockets 12 and deposited onto a separate belt for entry into the further cooking apparatus 16. The stirred egg product portions can be removed or de-panned from the heated pockets 12 in any manner known in the art. In some embodiments, the belt 20, and thereby the heated pockets 12 situated thereupon, can simply be tilted such that the stirred egg product portions 180 slip out onto a separate belt to be carried into the further cooking apparatus 16.

Egg product portions which have been processed according to the present invention can be referred to as “homestyle egg product portions”. Homestyle egg product portions resemble, in appearance and mouthfeel, eggs made by hand on a skillet. Mouthfeel refers to the tactile sensations perceived in the mouth when eating or drinking food products. The present invention provides the consumer of the homestyle egg product portions a similar experience as one would have if they were eating home-made eggs.

Distinctive qualities of homestyle egg portions are a surface of the egg product portion which is roughened due being disturbed while cooking rather than being substantially flat. In embodiments in which egg product portions are further cooked immediately after being stirred (without being gathered), the homestyle egg product portions substantially maintains the shape of the heated pocket, but has a roughened surface. The appearance of an imperfect surface of the homestyle egg product portions can be desirable to consumers compared to conventional commercially prepared eggs whose surface has not been disturbed while cooking. Egg product portions made according to the present invention also tend to have a lighter texture or lessened density due to stirring the eggs while cooking in the heated pockets. This lighter texture and roughened surface can provide a mouthfeel which certain consumers prefer compared to eggs made conventionally on a commercial scale.

In embodiments of the present invention which include food particulates in the egg product portions, the stirring mechanism causes some of the food particulates to be visible, and actually break through the surface of the homestyle egg product portions rather than simply falling to the bottom of the heated pockets and not being visible. As these food particulates are held on the surface of the homestyle egg product portion, rather than being internal, they can significantly affect the consumer's experience. The visibility of these food particulates can make the homestyle egg product portions of the present invention even more closely resemble eggs made by hand on a skillet. Additionally, the fact that some of the food particulates have broken through the surface results in a homestyle egg product portion whose surface is even more roughened.

Thus, in some embodiments, the present invention provides a one-piece homestyle egg product portion which can substantially retain a pre-defined shape (of a heated pocket), but has a roughened surface which more closely resembles eggs prepared by hand rather than some typical commercial processes. These homestyle egg product portions can fulfill requirements of certain commercial applications which require that egg portions retain a certain shape, while also providing the advantages of a more homestyle appearance and mouthfeel.

In embodiments of the present invention which do not necessarily require a substantially predefined shape, referring to FIGS. 2, and 6a-6e, the stirred egg product portions 180 are additionally gathered prior to being further cooked. Referring to FIGS. 6a and 6b, the heated pockets 12 with stirred egg product portions 180 move axially 22 until they are situated below the groupers 24.

Referring particularly to FIG. 6b, once the leading edge of a row of heated pockets containing stirred egg product portions 180 is below the groupers 24, the grouper support structure 240 causes the groupers 24 to descend until they contact the angled side 124 of the moving heated pocket 12 which would be first to pass under the groupers 24. Heated pockets 24 utilized in embodiments of the present invention having groupers 24 typically will have sides 124 which are angled 126 at greater than 90 degrees relative to their base 122.

The apparatus is specifically timed such that the groupers 24 will contact the heated pockets 12 at this leading side 125 of the heated pocket. The groupers 24 are then held substantially rigid in the axial direction such that they are not forced to move axially 22. A downward pressure is applied to the groupers 24 such that they follow the contours of the moving heated pocket 12.

Referring to FIG. 6c, as the heated pockets 12 continue to move axially 22, the groupers 24 slide down the leading side 125 of the heated pockets 12 until they are touching the base 122 of the heated pockets 12. At this point, the groupers 24 have also made contact with the stirred egg product portions 180. Referring to FIG. 6d, as the heated pockets 12 continue to move axially 22 the stirred egg product portions 180 held therein are compressed together, or gathered between the groupers 24 and the following side 127 of the heated pockets. The groupers 24 remain descended until approximately ¼ to ½ of a heated pocket 12 has moved axially 22 past the grouper 24. Referring to FIG. 6e, the groupers 24 then ascend and prepare to gather the stirred egg product portions 180 in the next row of heated pockets 12.

Referring to FIGS. 2 and 6e, because the eggs are continuously being cooked by the heated pockets 12 and the eggs are not in a completely liquid phase, after the groupers 24 ascend, the gathered egg product portions 186 do not expand to again fill the heated pockets 12. Instead, the gathered egg product portions 186 typically expand slightly and maintain an irregular shape within the heated pockets 12. After gathering, the gathered egg product portions 186 can be further cooked in similar fashion as described above for embodiments of the present invention without a plurality of groupers 24.

In this embodiment, the homestyle egg product portions not only have a roughened surface, but also an irregular shape. In addition to the advantages described above for the roughened surface, visibility of food particulates, and mouthfeel, the irregular shape of homestyle egg product portions in this embodiment advantageously even more closely resembles eggs made by hand on a skillet.

### Methods

The apparatuses described herein are useful in methods for producing homestyle egg product portions on a commercial scale. One method includes the steps of (a) providing a plurality of moving heated pockets; (b) placing an egg product portion into each heated pocket; (c) mechanically stirring the egg product portions within the heated pockets to yield stirred egg product portions; (d) mechanically gathering the stirred egg product portions to yield gathered egg product portions; and (e) further cooking the gathered egg product portions to yield homestyle egg product portions. The method can further include the step of (f) cooling the homestyle egg product portions to yield reduced temperature homestyle egg product portions. The method can even further include the step of (g) packaging the reduced temperature homestyle egg product portions.

In step (a), the heated pockets can consist of any of the dimensions and shapes, and can be held at any of the temperature ranges described above. The heated pockets can also be situated on a moving belt.

Prior to step (b), a release agent can be added to the heated pockets. The release agent can be an oil or other composition which can aid in the removal of the egg product portion from the heated pocket. The oil can be any oil typically used to remove, or lessen sticking of, cooked food from a skillet including, but not limited to, corn oil, canola oil, and soybean oil.

In step (b), the egg product portions can be added to the heated pockets in any manner known in the art. Typically, a tank holds premixed egg product that can be apportioned mechanically into each heated pocket. In embodiments where the egg product includes food particulates, these food particulates will generally be part of the premixed egg product. In some instances, however, the food particulates may also be added separately to the heated pockets.

In steps (c), (d), and (e), the egg product portions can be stirred, gathered, and further cooked using a mixer, grouper, and further cooking mechanism as described above.

In step (f), the homestyle egg product portions can be cooled using any method known in the art. In some embodiments, the homestyle egg product portions may be placed in a conventional refrigerator. In other embodiments, the homestyle egg product portions may be placed in a conventional freezer. In yet other embodiments, the homestyle egg product portions may be individually quick frozen. The reduced temperature homestyle egg product portions can be held at a temperatures ranging from −10° F. to 45° F. (−23° C. to 7° C.). In some embodiments requiring a very reduced temperature, the reduced temperature homestyle egg product portions can be held at a temperatures ranging from −10° F. to 10° F. (−23° C. to −12° C.). In other embodiments, the reduced temperature homestyle egg product portions can be held at a temperatures ranging from 10° F. to 39° F. (−23° C. to 3.9° C.). In yet other embodiments, the reduced temperature homestyle egg product portions can be held at a temperatures ranging from 32° F. to 39° F. (0° C. to 3.9° C.).

In step (g), the reduced temperature homestyle egg product portions can be packaged. These reduced temperature homestyle egg product portions can be utilized in the commercial retail food service industry.

Another method for producing homestyle egg product portions is also described. This method includes substantially the same steps as described above, except that the stirred egg product portions are not mechanically gathered to yield gathered egg product portions prior to further cooking. Instead, the stirred egg product portions proceed directly to the further cooking step without being gathered. These stirred, but not gathered egg product portions substantially retain the shape of the heated pocket and also have a roughened top surface texture.

### EXAMPLES

The present invention is further illustrated by the examples provided below. It is understood that these examples are not intended to limit the scope of the present invention in any way.

Examples 1-3 compare the surface of eggs which have been stirred while cooked with eggs which have been cooked without any stirring.

### Example 1

### Control Sample 1

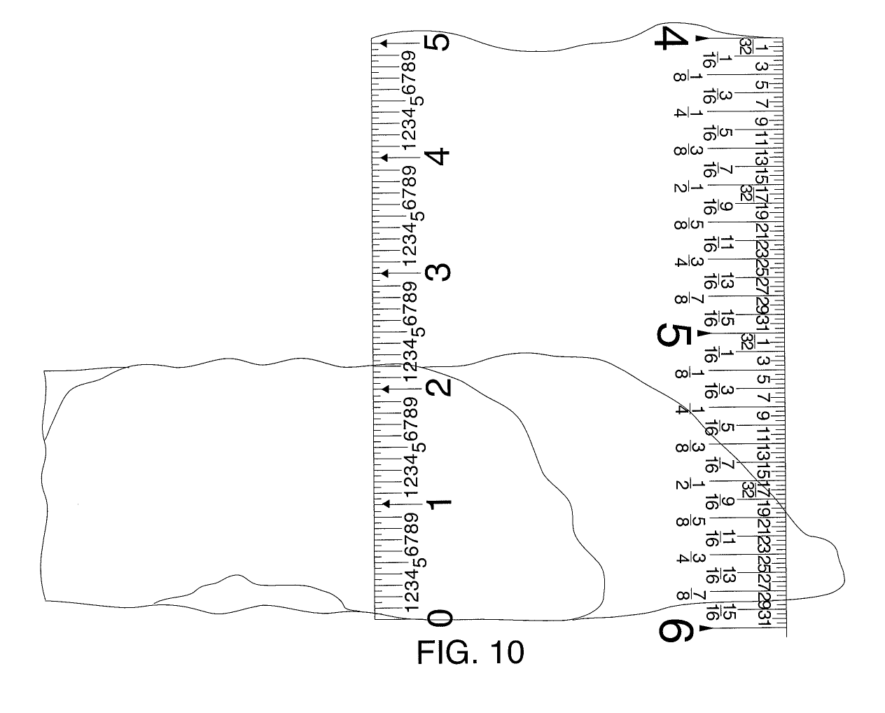

Control Sample 1 was produced as follows: A pocket (having a Teflon® coating) was heated by flame to a temperature in the range of 280° F. to 300° F. (138° C. to 149° C.). The pocket was rectangular in shape with 2.75 inch×3.25 inch (6.99 cm×8.26 cm) top and a depth of ⅝ inch (1.59 cm) depth. A small amount of release agent was added to the heated pocket. 1.5 oz (42.5 g) of a whole egg blend formula was then deposited onto the heated pocket. The whole egg blend formula was allowed to cook for 90 seconds in the heated pocket. The whole egg blend formula in the heated pocket was then placed in a further cooking apparatus and allowed to cook for another 90 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera. FIG. 10 shows a cross section of the frozen egg portion.

Experimental Sample 1

Experimental Sample 1 was produced as follows: A pocket substantially identical in shape, dimension, and temperature to that for Control Sample 1 was used. A small amount of release agent was added to the heated pocket. 1.5 oz (42.5 g) of a whole egg blend formula (the same formula as used in Control Sample 1) was then deposited onto the heated pocket. The whole egg blend formula was allowed to cook for 60 seconds in the heated pocket. The whole egg blend formula was stirred twice during the 60 seconds of cooking in the heated pocket—after 25 seconds and again after 45 seconds. For each stirring cycle, a mixer having 2 fingers was utilized to stir the whole egg blend formula. The heated pocket was stationary during each stirring. The fingers used for stirring each had a ⅜ inch (0.95 cm) diameter and the portion of the fingers which contacted the eggs was made of a silicon composite material. The fingers were lowered into the heated pocket, and the eggs therein, such that they lightly touched the base of the pocket. The fingers moved in a circular modal within the heated pocket for 2-4 seconds during each stirring. After each stirring was complete, the mixer was raised from the heated pocket.

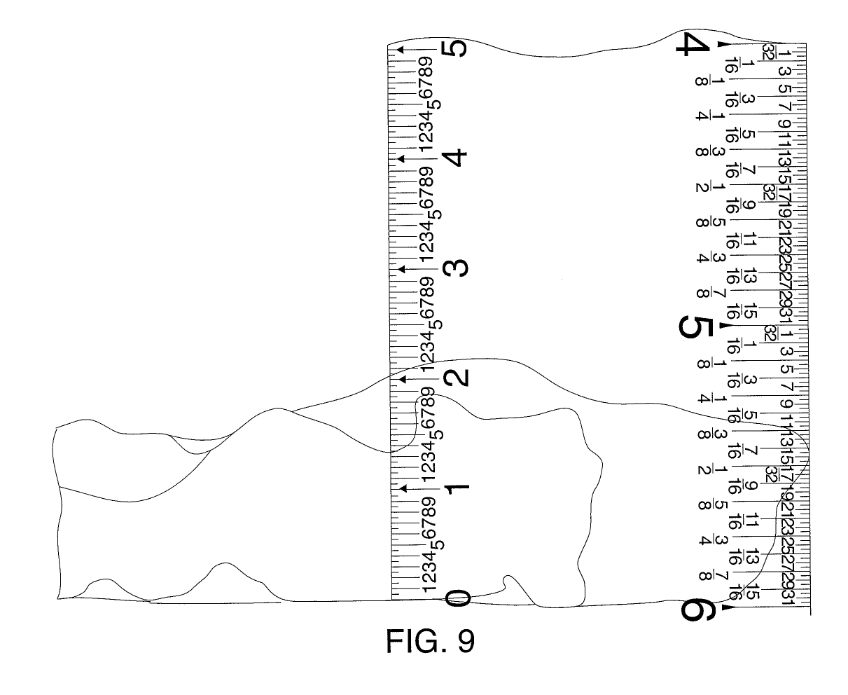

After being cooked for 60 seconds in the heated pocket, the stirred whole egg blend formula in the heated pocket was then placed in a further cooking apparatus and allowed to cook for another 30 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera. FIG. 9 shows a cross section of the frozen egg portion.

Results

The top surfaces of Control Sample 1 and Experimental Sample 1 were compared by visual inspection. Visual inspection showed that Experimental Sample 1 had a significantly more disturbed and roughened surface than Control Sample 1. This contrast can also be noted by referring to FIGS. 9 and 10.

### Example 2

### Control Sample 2

Control Sample 2 was produced as follows: A pocket (having a Teflon® coating) was heated by flame to a temperature in the range of 280° F. to 300° F. (138° C. to 149° C.). The pocket was rectangular in shape with 2.75 inch×3.25 inch (6.99 cm×8.26 cm) top and a depth of ⅝ inch (1.59 cm) depth. A small amount of release agent was added to the heated pocket. 1.5 oz (42.5 g) of a whole egg blend formula was then deposited onto the heated pocket. The whole egg blend formula was allowed to cook for 90 seconds in the heated pocket. The whole egg blend formula in the heated pocket was then placed in a further cooking apparatus and allowed to cook for another 120 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera.

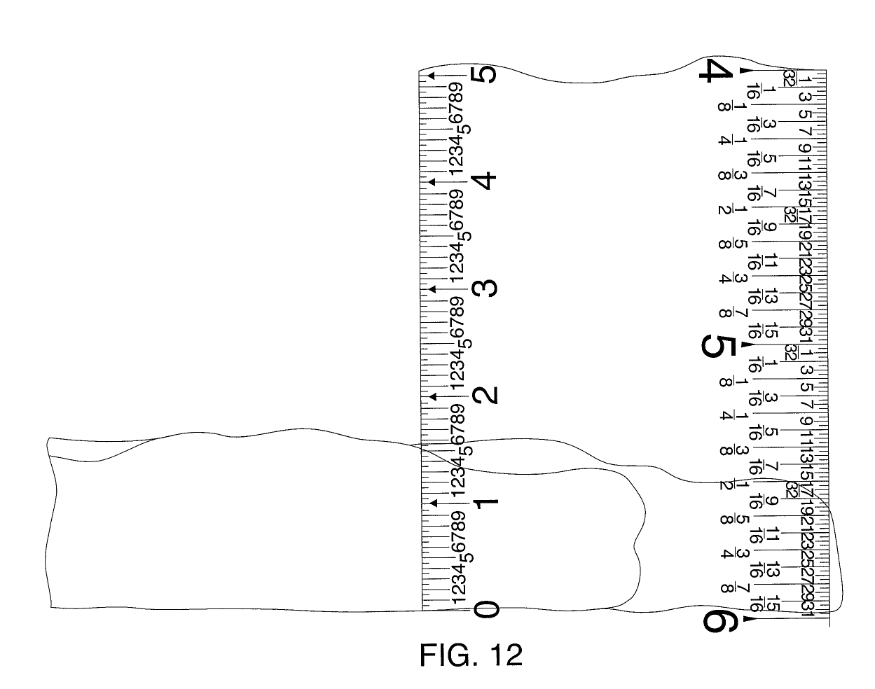

FIG. 12 shows a cross section of the egg portion.

Experimental Sample 2

Experimental Sample 2 was produced as follows: A pocket substantially identical in shape, dimension, and temperature to that for Control Sample 2 was used. A small amount of release agent was added to the heated pocket. 1.5 oz (42.5 g) of a whole egg blend formula (the same formula as used in Control Sample 2) was then deposited onto the heated pocket. The whole egg blend formula was allowed to cook for 90 seconds in the heated pocket. The whole egg blend formula was stirred three times during the 90 seconds of cooking in the heated pocket—after 30 seconds, after 60 seconds, and again after 80 seconds. For each stirring cycle, a mixer having 2 fingers was utilized to stir the whole egg blend formula. The heated pocket was stationary during each stirring. The fingers each had a ⅜ inch (0.95 cm) diameter and the portion of the fingers which contacted the eggs was made of a silicon composite material. The fingers were lowered into the heated pocket, and the eggs therein, such that they lightly touched the base of the pocket. The fingers moved in a circular motion within the heated pocket for 2-4 seconds during each stirring. After each stirring was complete, the mixer was raised from the heated pocket.

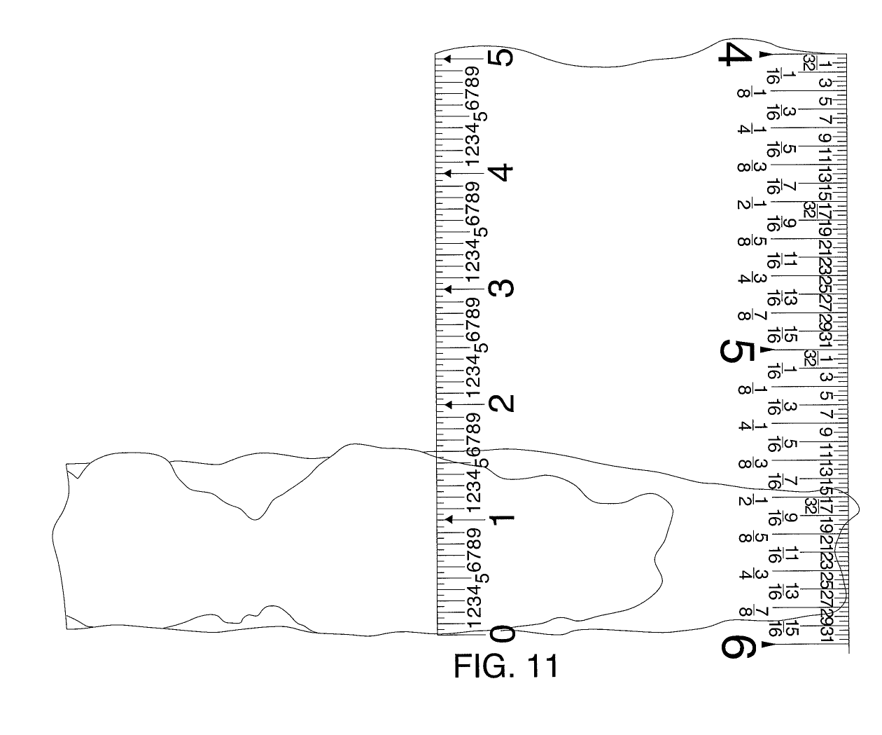

After being cooked for 90 seconds in the heated pocket, the stirred whole egg blend formula in the heated pocket was then placed in a further cooking apparatus and allowed to cook for another 30 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera. FIG. 11 shows a cross section of the egg portion.

Results

The top surfaces of Control Sample 2 and Experimental Sample 2 were compared by visual inspection. Visual inspection showed that Experimental Sample 2 had a significantly more disturbed and roughened surface than Control Sample 2. This contrast can also be noted by referring to FIGS. 11 and 12.

### Example 3

### Control Sample 3

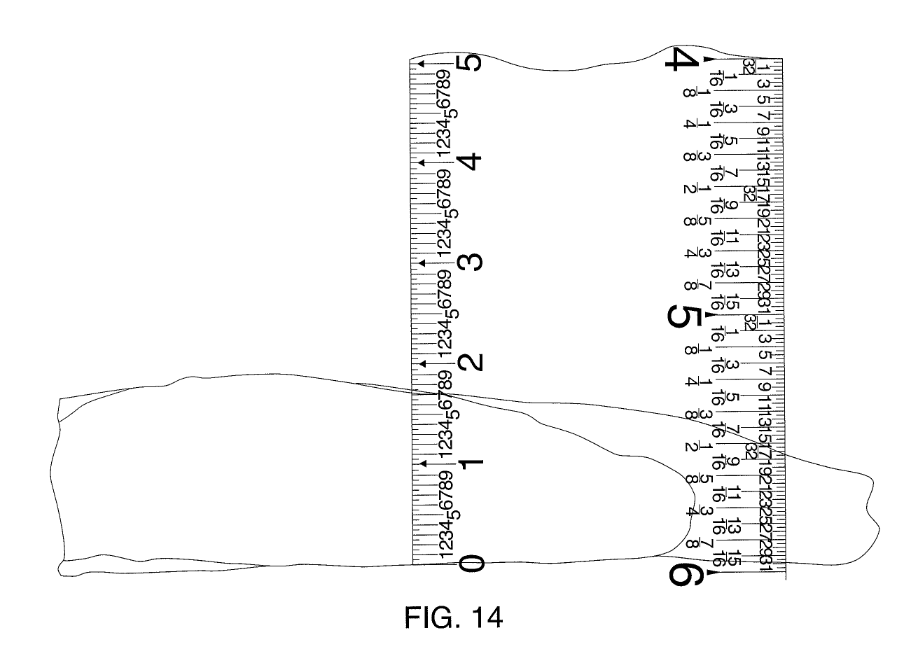

Control Sample 3 was produced as follows: A pocket (having a Teflon® coating) was heated by flame to a temperature in the range of 280° F. to 300° F. (138° C. to 149° C.). The pocket was circular in shape with 3.5 inch (8.9 cm) diameter top and a depth of ⅝ inch (1.59 cm) depth. A small amount of release agent was added to the heated pocket. 1.5 oz (42.5 g) of a whole egg blend formula was then deposited onto the heated pocket. The whole egg blend formula was allowed to cook for 90 seconds in the heated pocket. The whole egg blend formula in the heated pocket was then placed in a further cooking apparatus and allowed to cook for another 90 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera. FIG. 14 shows a cross section of the egg portion.

Experimental Sample 3

Experimental Sample 3 was produced as follows: A pocket substantially identical in shape, dimension, and temperature to that for Control Sample 3 was used. A small amount of release agent was added to the heated pocket. 1.5 oz (42.5 g) of a whole egg blend formula (the same formula as used in Control Sample 3) was then deposited onto the heated pocket. The whole egg blend formula was allowed to cook for 90 seconds in the heated pocket. The whole egg blend formula was stirred three times during the 90 seconds of cooking in the heated pocket—after 30 seconds, after 60 seconds, and again after 80 seconds. For each stirring cycle, a mixer having 2 fingers was utilized to stir the whole egg blend formula. The heated pocket was stationary during each stirring. The fingers each had a ⅜ inch (0.95 cm) diameter and the portion of the fingers which contacted the eggs was made of a silicon composite material. The fingers were lowered into the heated pocket, and the eggs therein, such that they lightly touched the base of the pocket. The fingers moved in a circular motion within the heated pocket for 2-4 seconds during each stirring. After each stirring was complete, the mixer was raised from the heated pocket.

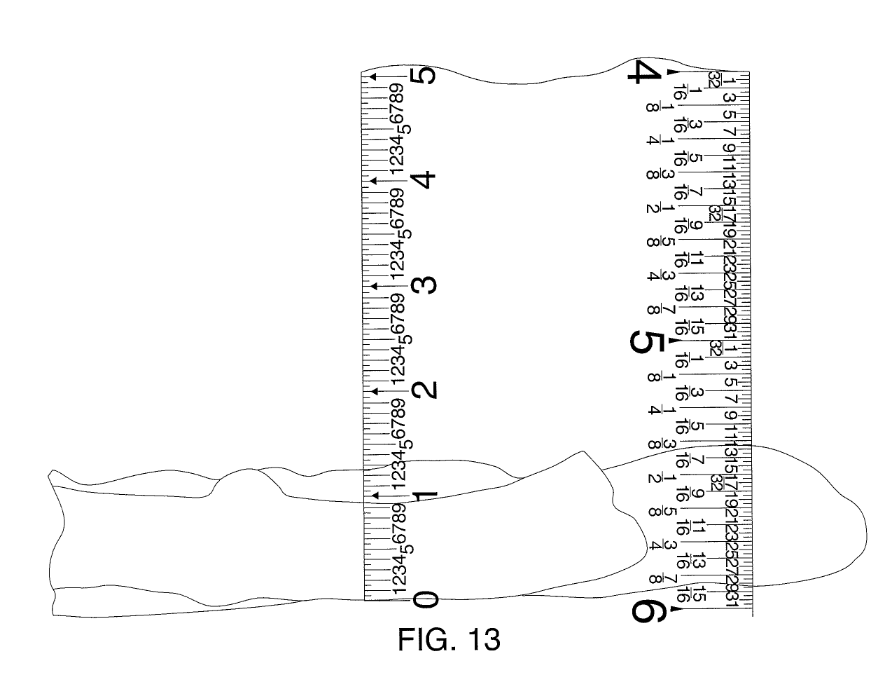

The stirred whole egg blend formula in the heated pocket was then placed in a further cooking apparatus and allowed to cook for another 30 seconds at a temperature range of from 195° F. to 205° F. (91° C. to 96° C.). After completion of cooking, the egg portion was removed or de-panned from the heated pocket. The cooked egg portion was placed in dry ice for 30 minutes until frozen. The frozen egg portion was photographed using a digital camera. FIG. 13 shows a cross section of the egg portion.

Results

The top surfaces of Control Sample 3 and Experimental Sample 3 were compared by visual inspection. Visual inspection showed that Experimental Sample 3 had a significantly more disturbed and roughened surface than Control Sample 3. This contrast can also be noted by referring to FIGS. 13 and 14.

1-20. (canceled)

21. A method for producing homestyle egg product portions on a commercial scale comprising the steps of:
(a) providing a plurality of moving heated pockets;
(b) placing an egg product portion into each heated pocket;
(c) mechanically stirring the egg product portions within the heated pockets to yield stirred egg product portions;
(d) mechanically gathering the stirred egg product portions to yield gathered egg product portions; and
(e) further cooking the gathered egg product portions to yield homestyle egg product portions.

22. The method of claim 21, further comprising the step of:
(f) cooling the homestyle egg product portions to yield reduced temperature homestyle egg product portions.

23. The method of claim 21, further comprising the step of:
(g) packaging the reduced temperature homestyle egg product portions.

24. The method of claim 21, wherein a release agent is added to the heated pocket before the egg product portion is placed into the heated pocket.

25. The method of claim 24, wherein the release agent comprises soybean oil.

26. The method of claim 11, wherein the egg product portions comprise whole eggs, egg whites, a combination of whole eggs and egg whites, whole eggs with food particulates, egg whites with food particulates, or a combination of whole eggs and egg whites with food particulates.

27. The method of claim 26, wherein the food particulates comprise pepper pieces, onion pieces, tomato pieces, or bacon pieces.

28. The method of claim 11, wherein the temperature of the heated pockets is within the range of between 250° F. and 300° F. (121° C. and 149° C.).

29. The method of claim 11, wherein the temperature of the heated pockets is within the range of between 270° F. and 300° F. (132° C. and 149° C.).

30. The method of claim 11, wherein step (c) comprises inserting a mechanical finger into the egg product portion and moving the mechanical finger about a circular motion within the egg product portion.
